(19) United States
(12) Patent Application Publication
(10) Pub. No.: US 2007/0262908 A1
(43) Pub. Date: Nov. 15, 2007

(54) WIRELESS SIGNAL RECEPTOR ANTENNA AND METHOD INSTALLATION THEREOF

(75) Inventor: Hui-Hsiang YU, Sindian City (TW)

Correspondence Address: EGBERT LAW OFFICES, 412 MAIN STREET, 7TH FLOOR, HOUSTON, TX, 77002, US

(73) Assignee: WHA YU INDUSTRIAL Co., Ltd., Hsinchu City (TW)

(21) Appl. No.: 11/554,305

(22) Filed: Oct. 30, 2006

(30) Foreign Application Priority Data
May 15, 2006 (TW) 095117159

(51) Int. Cl. H01Q 1/24

(52) U.S. Cl. 343/702

(57) ABSTRACT

The present invention provides an installation method of a wireless signal receptor antenna and a structure with a wireless signal receptor. The structure includes a flexible antenna and a device to move the antenna from a first configuration to a second configuration. The first configuration is collapsed and movable, and the second configuration has the antenna extended. The antenna can be in the first collapsed and movable mode, when placed inside the apparatus. The invention allows the antenna to be placed inside a small apparatus and to receive quality signals.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to an installation method and structure of a wireless signal receptor antenna, and more particularly to an antenna that is used inside a small apparatus.

2. Description of Related Art Including Information Disclosed Under 37 CFR 1.97 and 37 CFR 1.98.

In a wireless application, the antenna is a very important component to transmit signals. The electronic features of the antenna affects the quality of transmission. Because the antenna has to match a smaller, thinner electronic apparatus and still has to transmit the signal, the industry has to develop a smaller antenna to meet the requirements of the new apparatuses.

The development of the new generation of electronics includes combining wireless transmission and the internet, for example, digital TV, 3G mobile service, web page browsing, and e-commerce. In order to receive high quality images on screens of these electronics, the function of the antenna is increasingly important. Because the length of the antenna correlates to frequency, certain frequencies must have a longer antenna. For this reason, the antenna cannot be placed inside the apparatus. For example, a digital TV can receive a signal through a cell phone; although currently, the signal is received through a 3G (3rd Generation) system because of the antenna of the cell phone is compatible. When the user's phone is on “Package Switch Mode” to transmit the signal, the 3G business charges an expensive service fee. It is a challenge to place the antenna inside a small apparatus, like a cell phone, because of its length. The conventional method is to place the antenna outside the apparatus or install an extra receiver; however, these conventional methods create disadvantages of poor signal quality and inability to fit in the apparatus because the size of the antenna takes too much room.

Thus, to overcome the aforementioned problems of the prior art, it would be an advancement in the art to provide an improved structure that can significantly improve efficacy.

To this end, the inventor has provided the present invention of practicability after deliberate design and evaluation based on years of experience in the production, development and design of related products.

### BRIEF SUMMARY OF THE INVENTION

As shown in FIGS. 1 and 2, the means of pushing 40 the apparatus 30 is achieved by the apparatus body 31 of the apparatus 30. The sliding cover 32 is placed on one side of the apparatus body 31. The sliding cover 32 is closed to the apparatus body 31. Thus, the antenna 10 can be in a collapsed and movable mode 20 and be placed inside the apparatus 30. The entire length of the apparatus 30 can be shortened using this collapsing method, so that the antenna 10 can be placed inside the small apparatus 30. When the apparatus 30 receives a signal, the sliding cover 32 can slide upward to the top of the apparatus body 31. Using the sliding cover 32 to extend the antenna to the length needed, the antenna 10 meets the needs for certain frequencies and further receives signals steadily.

As shown in FIGS. 3 and 4, the apparatus 30 is a single apparatus body 31. The antenna 10 is in the collapsed and movable mode 20 and is placed inside the apparatus. The entire length of the apparatus 30 can be shortened using this collapsing method, so that the antenna 10 can be placed inside the small apparatus 30. When the apparatus 30 receives signal, the pushing button 33 can slide upward to the top of the apparatus body 31. Using the pushing button 33 to extend the antenna to the length needed, the antenna 10 meets the needs for certain frequencies and further receives signals steadily.

As shown in FIGS. 5 and 6, the means of folding 50 the apparatus 60 has an apparatus body 61 and a casing 62 on one terminal of the apparatus body 61. The casing 62 is lifted toward one certain direction or covers one side of the apparatus. The casing 62 is closed to the apparatus body 61, and one terminal 11 of the antenna is positioned inside the casing 62. The other terminal 12 is positioned inside the apparatus body 61. Therefore, the antenna can be placed inside a small apparatus. When the apparatus receives signals, the casing 62 can be lifted toward a certain direction, using the casing 62 to extend the antenna 10 to the length needed. So that the antenna 10 now meets the needs for certain frequencies and further receives signalssteadily.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a side elevation view of the first preferred embodiment of the present invention in a cell phone.

FIG. 2 shows another side elevation view of the first preferred embodiment of the present invention in an extended position.

FIG. 3 shows a side elevation view of the second preferred embodiment of the present invention in another cell phone.

FIG. 4 shows another side elevation view of the second preferred embodiment of the present invention in an extended position.

FIG. 5 shows still another side elevation view of the third preferred embodiment of the present invention in still another cell phone.

FIG. 6 shows still another side elevation view of the third preferred embodiment of the present invention in an extended position.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

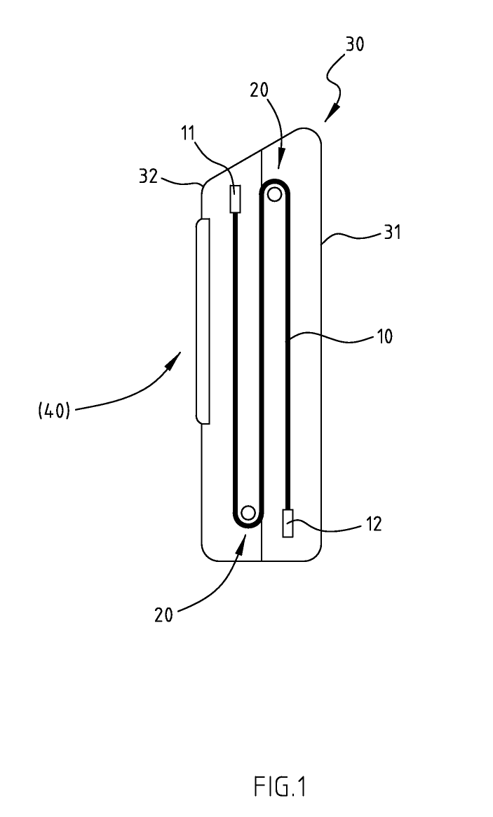

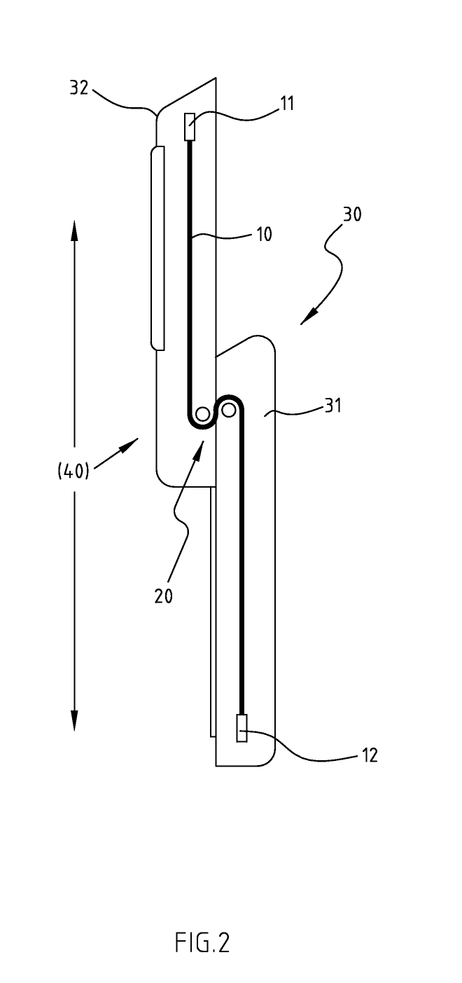

As shown in FIGS. 1 and 2, there is the installation method of wireless signal receptor antenna.

A flexible antenna 10 is placed inside the apparatus 30 in a collapsed and movable mode 20. A pushing means 40 is placed on the apparatus 30 for the antenna 10 to be extended or collapsed.

The present invention provides an installation method of the wireless signal receptor antenna. The pushing means 40 is achieved by the apparatus body 31 of the apparatus 30 and a sliding cover 32 placed on one side of the apparatus body 31 toward a certain direction. A terminal 11 of the antenna 10 is positioned inside the sliding cover 32, and the other terminal 12 is positioned inside the apparatus body 31. The antenna 10 is in the collapsed and movable mode 20 between the two terminals 11, 12 in the space between the apparatus body 31 and the sliding cover 32. The collapsed and movable mode 20 of the antenna 10 has a zig-zag shape.

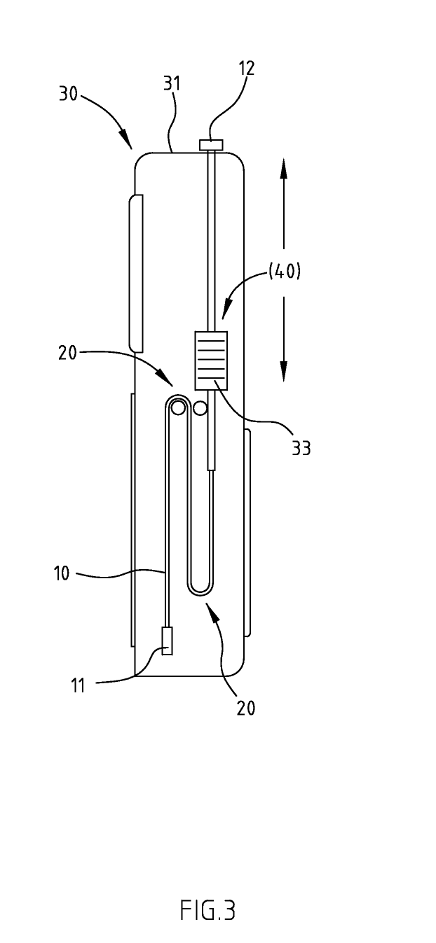

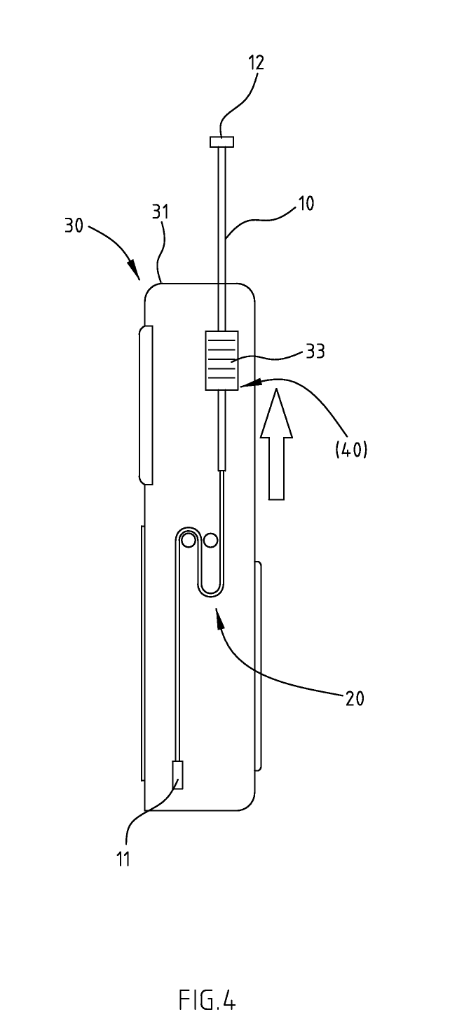

As shown in FIGS. 3 and 4, there is another installation method of the wireless signal receptor antenna. The apparatus 30 is a single apparatus body 31, so that a terminal 11 of the antenna 10 can be positioned inside the apparatus 30. The other terminal is placed outside the apparatus 30, so that the antenna 10 can be placed inside the apparatus 30 in the collapsed and movable mode 20.

In the embodiment of FIGS. 3 and 4, the pushing means 40 can be achieved by placing a push bottom 33 on the external wall of the apparatus 30. The inside of the push bottom 33 is connected to the antenna 10 inside the apparatus 30, so that the push bottom 33 can slide toward a certain direction and drive one terminal 12 of the antenna 10 to the outside of the apparatus 30. The collapsed and movable mode 20 of the antenna 10 has a zig-zag shape in this embodiment as well.

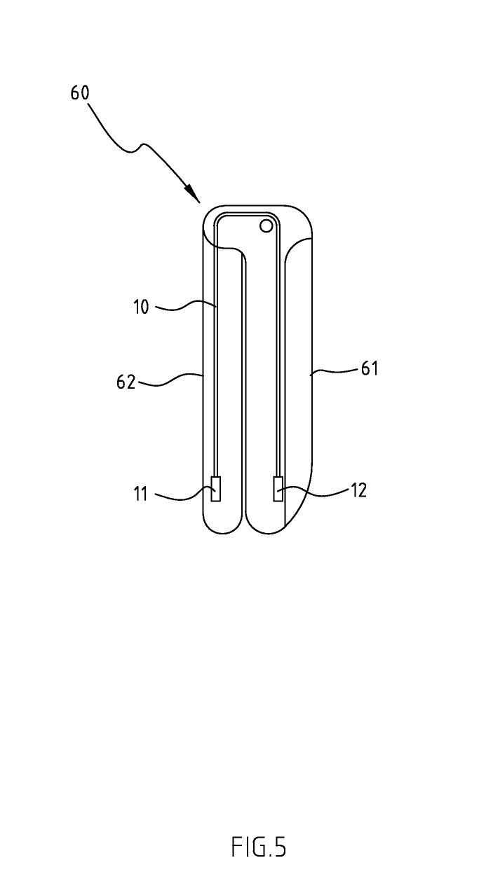

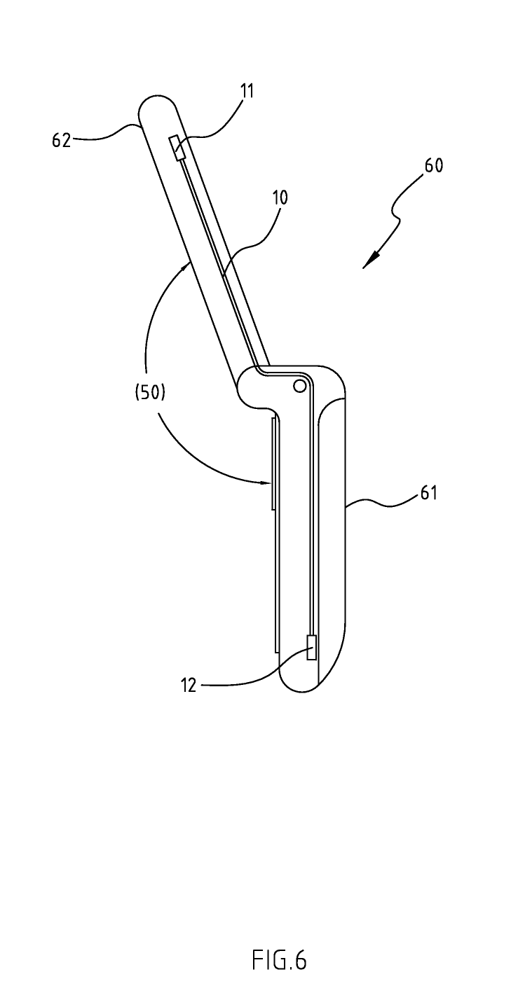

As shown in FIGS. 5 and 6, there is still another installation method of wireless signal receptor antenna. A flexible antenna 10 is placed inside the apparatus 30 in a collapsed and movable mode 20. A folding means 50 is placed on the apparatus 30 for the antenna 10 to be extended or collapsed.

In the embodiment of FIGS. 5 and 6, the present invention provides an installation method of the wireless signal receptor antenna. The folding means 50 is achieved by the apparatus body 61 of the apparatus 60. By one terminal of the apparatus body 61 lifting the casing 62 toward a certain direction, one terminal 11 of the antenna 10 is positioned inside the casing 62, and the other terminal 12 is positioned inside the apparatus body 61. The collapsed and movable mode 20 of the antenna 10 has a folded shape.

As shown in FIGS. 1 and 2, the structure with a wireless signal receptor antenna is shown.

An apparatus 30 has an apparatus body 31 and a sliding cover 32 on one side of the apparatus body 31. The sliding cover 32 is able to slide toward a certain direction.

An antenna 10 can be collapsed and has at least two terminals 11, 12. One terminal 11 is positioned inside the sliding cover 32, and the other terminal 12 is positioned inside the apparatus body 31. The antenna 10 can be in the collapsed and movable mode 20 between the two terminals 11, 12 in the space between the apparatus body 31 and the sliding cover 32.

As shown in FIGS. 3 and 4, another structure with a wireless signal receptor antenna is shown.

The structure includes an apparatus 30, an antenna 10, and a push button 33. The antenna 10 can be collapsed and has at least two terminals 11, 12. One terminal 11 is positioned inside the apparatus 30, and the other terminal 12 is positioned outside the apparatus 30. The antenna 10 can be in the collapsed and movable mode 20 between the two terminals 11, 12 inside the apparatus 30. The push button 33 can be placed on the apparatus 30, sliding toward a certain direction. The inside of the push button 33 is connected to the inside of the apparatus 30 near the antenna 10 on top.

As shown in FIGS. 5,6, still another structure with a wireless signal receptor antenna is shown.

An apparatus 60 has an apparatus body 61 and a casing 62 on one terminal of the apparatus body 61 that is lifted toward one certain direction or covers one side of the apparatus. An antenna 10 can be collapsed and has at least two terminals 11, 12. One terminal 11 is positioned inside the casing 62, and the other terminal 12 is positioned inside the apparatus body 61.

We claim:

1. An installation method of a wireless signal receptor antenna, comprising the steps of:
placing an antenna inside an apparatus in a first configuration, said antenna being flexible; and
pushing said antenna placed inside said apparatus from said first configuration to a second configuration of said antenna, said antenna being extended in said second configuration.

2. The installation method defined in claim 1, wherein said antenna is collapsed and moveable in said first configuration.

3. The installation method defined in claim 1, wherein said step of pushing said antenna is comprised of:
positioning said antenna on said apparatus, said apparatus having an apparatus body and a sliding cover, said sliding cover being placed on one side of said apparatus body toward a set direction, said antenna having a terminal end and an opposite terminal end, said terminal end being positioned inside said sliding cover, said opposite terminal end being positioned inside said apparatus body; and
sliding said sliding cover in said set direction to extend said terminal end from said opposite terminal end, said antenna moving from said first configuration to said second configuration in space between said apparatus body and said sliding cover.

4. The installation method defined in claim 1, wherein said step of pushing said antenna is comprised of:
positioning said antenna on said apparatus, said apparatus being a single apparatus body with a push button on an external wall on said single apparatus body, said antenna having a terminal end and an opposite terminal end, said terminal end being positioned inside said apparatus, said opposite terminal end being positioned outside said apparatus, said push button being connected to said antenna inside said apparatus; and
sliding said push button toward a certain direction to extend said opposite terminal end further outside said apparatus.

5. An installation method of a wireless signal receptor antenna, comprising the steps of:
placing an antenna inside an apparatus in a first configuration, said antenna being flexible; and
folding said antenna placed inside said apparatus from said first configuration to a second configuration, said antenna being extended in said second configuration.

6. The installation method defined in claim 5, wherein said antenna is folded over and moveable in said first configuration.

7. The installation method defined in claim 5, wherein said step of folding said antenna is comprised of:
positioning said antenna on said apparatus, said apparatus having an apparatus body and a casing, said antenna having a terminal end and an opposite terminal end, said terminal end being positioned inside said apparatus body, said opposite terminal end being positioned inside said casing; and
lifting said casing from said apparatus body toward a certain direction to extend said terminal end from said opposite terminal end, said antenna moving from said first configuration to said second configuration.

8. A structure with a wireless signal receptor antenna, comprising:
an apparatus, having an apparatus body and a sliding cover, said sliding cover being placed on one side of said apparatus body and being slidable toward a certain direction; and
an antenna, being collapsed and having at least two terminals, one terminal being positioned inside said sliding cover, another terminal being positioned inside said apparatus body, said antenna being able to move from a first configuration to a second configuration in space between said apparatus body and said sliding cover, said antenna being extended in said second configuration.

9. The structure with a wireless signal receptor antenna of claim 8, wherein said antenna is collapsed and moveable in said first configuration.

10. The structure with a wireless signal receptor antenna of claim 8, wherein said antenna is folded over and moveable in said first configuration.

11. A structure with a wireless signal receptor antenna, comprising:
an apparatus; and
an antenna, being collapsed and having at least two terminals, one terminal being positioned inside said apparatus, another terminal being positioned outside said apparatus.

12. The structure defined in claim 11, further comprising:
a push button being placed on said apparatus and being slidable toward a certain direction, said push button being connected to the antenna inside of the apparatus.

13. A structure of wireless signal receptor antenna, comprising:
an apparatus, having an apparatus body and a casing, said casing being able to be lifted from said apparatus body toward one certain direction; and
an antenna, being collapsed and having at least two terminals, one terminal being positioned inside said casing, another terminal being positioned inside said apparatus body.
